(19) United States
(12) Patent Application Publication
(10) Pub. No.: US 2014/0329114 A1
(43) Pub. Date: Nov. 6, 2014

(54) System And Process For Maintaining Of Working Temperature Of Battery Cells For Starter Accumulators In Vehicles

(71) Applicant: Mate Rimac, Sveti Martin pod Okicem (HR)

(72) Inventor: Mate Rimac, Sveti Martin pod Okicem (HR)

(21) Appl. No.: 14/362,340

(22) PCT Filed: Dec. 2, 2011
(86) PCT No.: PCT/HR2011/000045

§ 371 Date: Jun. 2, 2014

(51) Int. Cl. H01M 10/625; H01M 10/48; H01M 10/6571; H01M 10/615; H01M 10/63

(52) U.S. Cl. CPC H01M 10/5016; H01M 10/5006; H01M 10/502; H01M 10/5083; H01M 10/486; H01M 2220/20
USPC 429/50; 429/62

(57) ABSTRACT

A battery management system to maintain cell temperature in automobile starter batteries, containing lithium-ion; lithium-iron-phosphate battery cells mutually connected in series and parallel. Cell temperature management and measurement, and voltage measurement of each individual battery cell and for cell heating management units have a temperature sensor mounted directly on one of the cells. A predefined upper temperature value t₂ and a lower temperature value t₁ are used to determine whether to activate or deactivate heating of the battery cells. The working temperature of the battery cells is maintained by a heater in the form of foil pasted over the cells, or, in case of flat cells, by a heater in the form of flat foil placed in between the cells or by a shared heater of any form inside the casing.

### TECHNICAL FIELD

The subject of this Invention is the battery management system (BMS) and process designed to maintain cell working temperature in vehicle starter batteries, especially the cells of the new generation of lithium-ion; lithium-iron-phosphate 12/24V starter battery cells.

### TECHNICAL PROBLEM

The lead batteries being used in automobiles weigh between 12 and 25 kg depending on the model. By replacing the lead batteries with a new generation of lithium batteries the weight would be greatly reduced and an improved product picture obtained in terms of environmental protection.

Due to its large mass and toxic ingredients, lead batteries are not considered a long-term solution for starting automobiles, trucks, other vehicles and products from similar areas of application. The subject of this Invention is the application of the new generation of 12 V batteries with systems that maintain optimum conditions for battery operation, featuring many advantages over the conventional lead battery, able to largely eliminate the shortcomings of the conventional battery in respect of bulky mass and toxic ingredients.

Lithium-iron-phosphate is a compound thinly applied to the anode and cathode layers of lithium-iron-phosphate battery cells. Such cells have proved to be the best choice for the new generation of 12V battery owing to a high degree of safety compared with other technologies (e.g., lithium-polymer or lithium-ion, long life (over 2000 charge/discharge cycles up to 80% capacity) and a relatively acceptable price per unit of stored energy.

However, tests have shown that at temperatures from 5 to 0° C. and lower a major fall in power potential (capability to give big currents without a big voltage drop) occurs. The technical problem being solved with the Invention is to maintain optimum conditions for the battery's operation, to keep the working temperature of battery cells if ambient temperature is too low for their functioning. This problem is solved in two possible ways: by having each cell of the battery pack in a direct contact with the heater or by providing a common heater for the whole battery pack, where heating is activated if required.

### PRIOR ART

Porsche, the only car manufacturer to launch the 12V Li-ion starter battery, offers its own Li-ion battery as a very easy alternative to the conventional lead battery, with a note that it operates only above zero (0° C.). This battery now serves as racing equipment, for roadtrack races, anyway not for everyday use. With the Li-ion battery the manufacturer also supplies the conventional lead battery for everyday use.

There is likewise no 12V Li-ion battery with active thermal management that maintains the working temperature of cells if ambient temperature is too low for their functioning. This shortcoming confines the operation of the 12V Li-ion batteries exclusively to a range above zero temperatures and thus does not provide safety and reliability for replacing the conventional battery.

### DESCRIPTION OF THE INVENTION

In order to avoid the low temperature problems encountered by similar systems, we have introduced the heating of battery cells to ensure unhindered work throughout the year and in all conditions.

Cell heating can be achieved in two ways, depending on the kind of application:
1. Each cell is in a direct contact with the heater (foil) which gets activated if required
2. The heater is shared by the whole battery pack

The temperature sensor is mounted directly on one of the cells and measures its temperature.

As the battery cell largely consists of metal (aluminium and copper), temperature is evenly distributed over the whole cell.

Our tests have shown that a sharp fall in energy potential (capability to generate big currents without a big voltage drop) occurs at temperatures from 0 do 5° C. and below. The program is so adjusted that the heaters are turned on when temperature falls below 0° C. and turned off when the cell temperature reaches 5° C. The ON/OFF parameters and algorithms of heating can be adjusted as desired, depending on ideal conditions of the used cell. In order to keep temperature high as long as possible, it is advisable to isolate the cells. It is also possible to fill the whole box (all cavities) with isolation foam. Since in heating the cells energy is used from the cells themselves, isolation is vital to ensure that energy is not be spent on heating, thus preventing the user to use the battery—e.g., automobile ignition.

There is a possibility of installing an algorithm which disables the heating function if the battery is not used for several days (the BMS is monitoring voltage development and records that for X days no voltage increase has taken place).

It is also possible to manually deactivate or activate heating by depressing the push-button on the box of the battery pack.

### BRIEF DESCRIPTION OF DRAWINGS

The Invention will be described below in detail with reference made to the following drawings:

FIG. 1—BMS software—operating diagram,

FIG. 2—appearance of a completed battery pack with a casing,

FIG. 3—battery pack—cross-section showing the main components inside the casing,

FIG. 4—view of the battery pack cover and the parts arranged on the upper side,

FIG. 5—front view of the battery pack,

FIG. 6—front view with a transparent casing to show the components inside,

FIG. 7—3D-view of the main components of the battery pack without the casing,

FIG. 8—side view of the battery pack with a transparent casing,

FIG. 9—battery pack cross-section with all the components inside,

FIG. 10—characteristic of lithium-iron-phosphate batteries (ratio between voltage and charge status),

FIG. 11—screen, and

FIG. 12—example of a battery pack with flat cells.

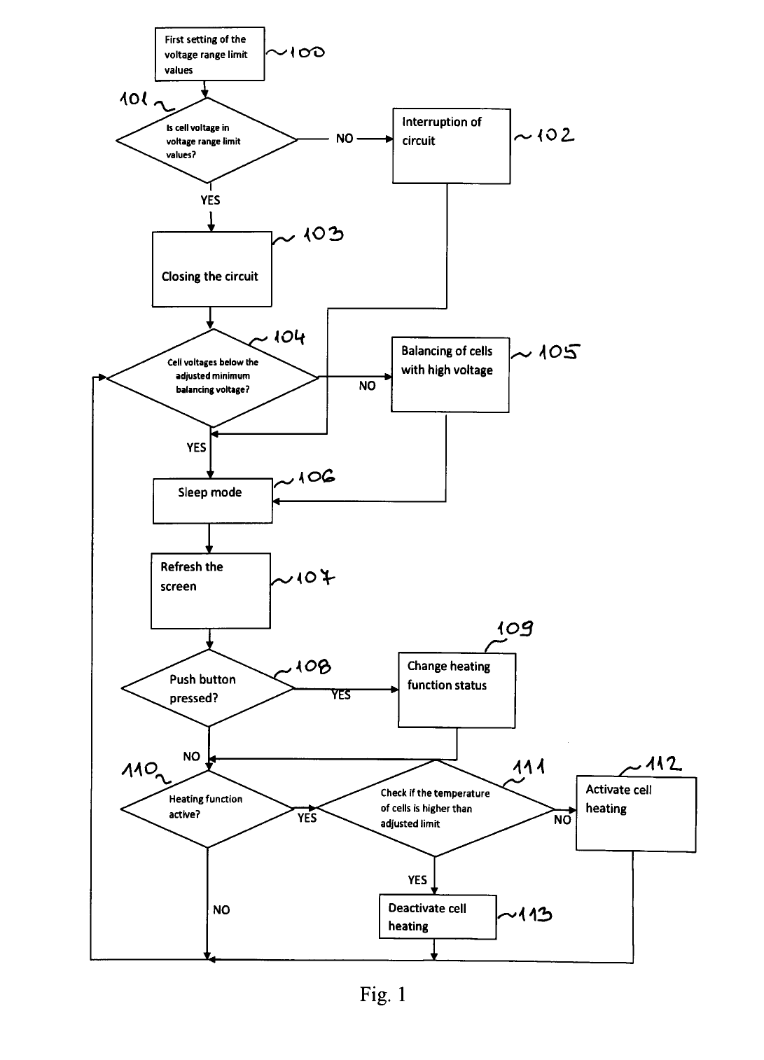

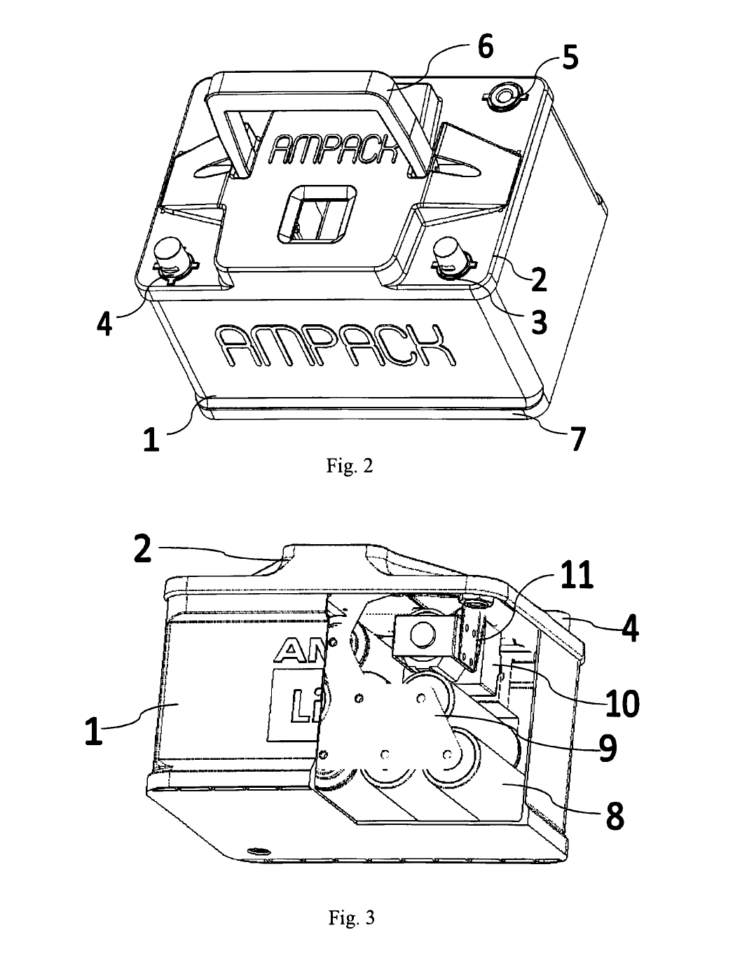

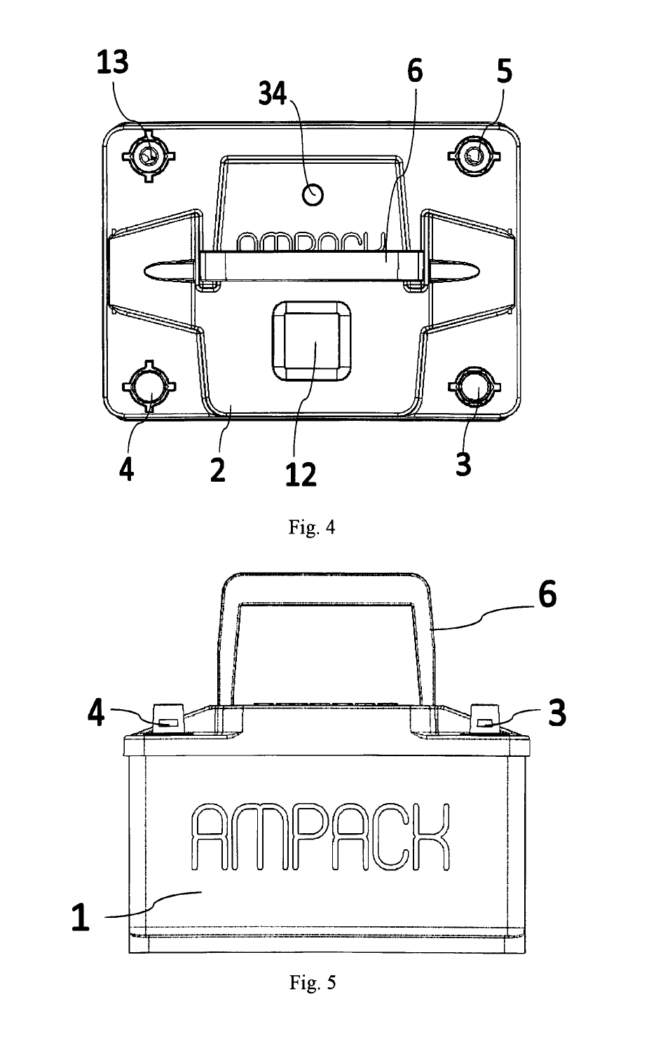

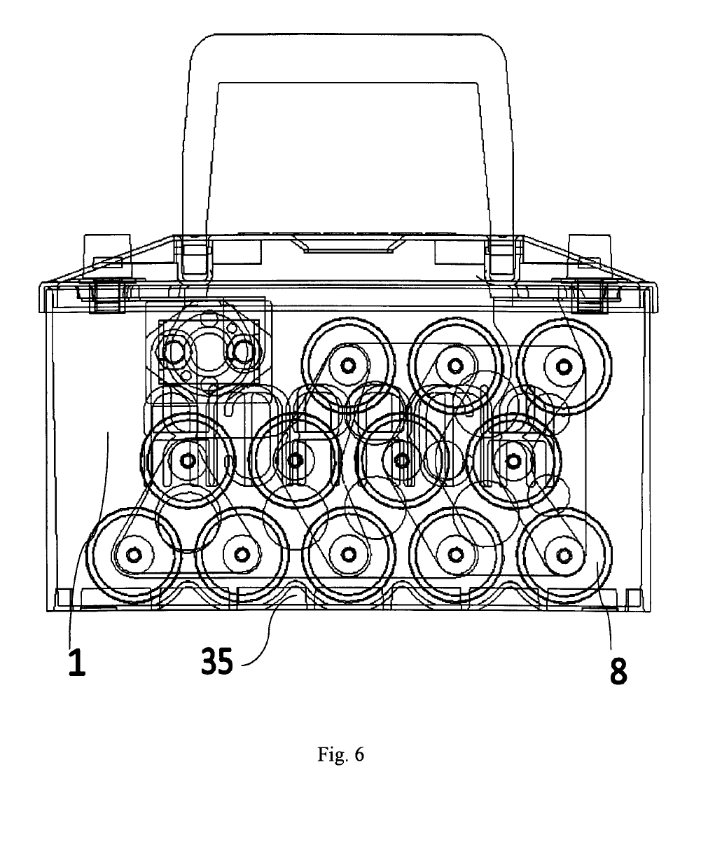

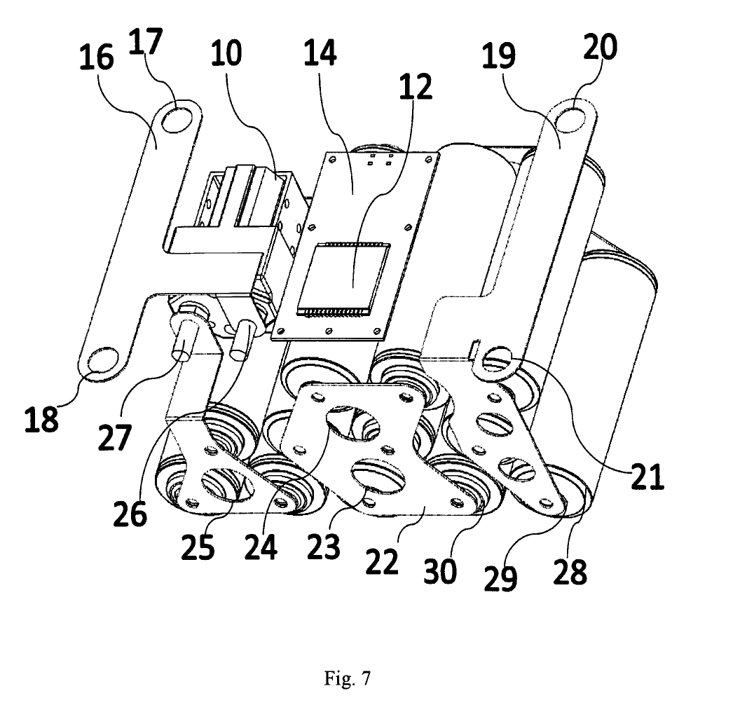

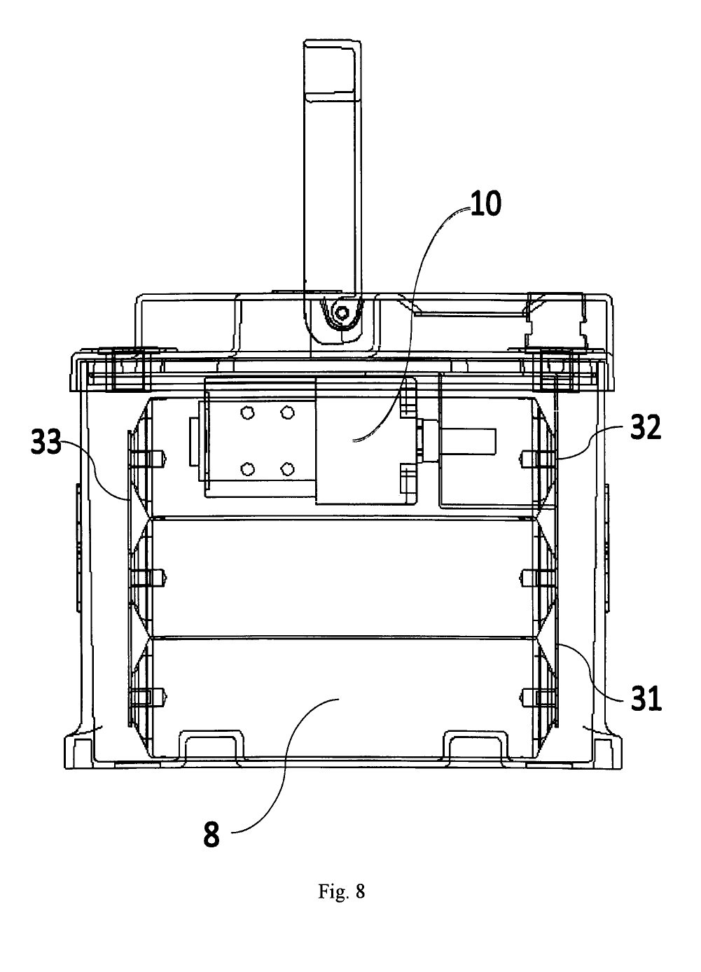

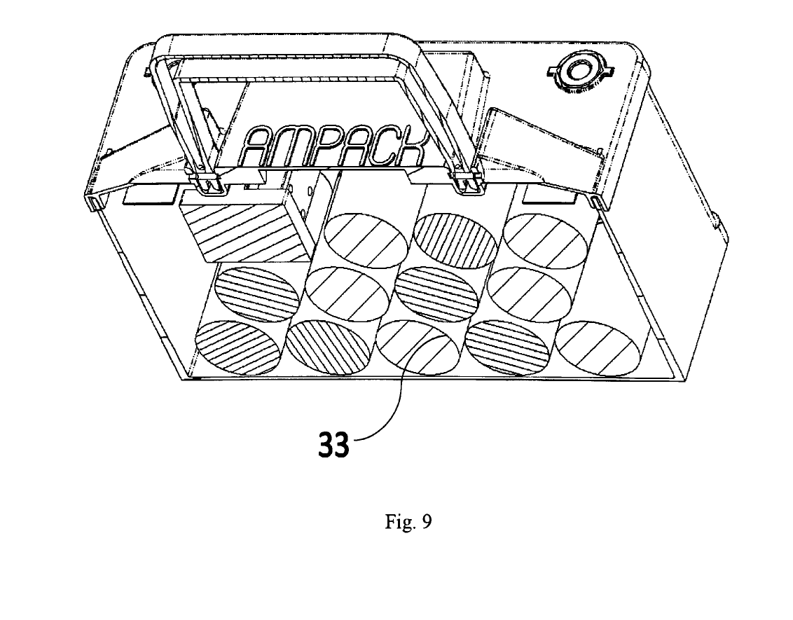

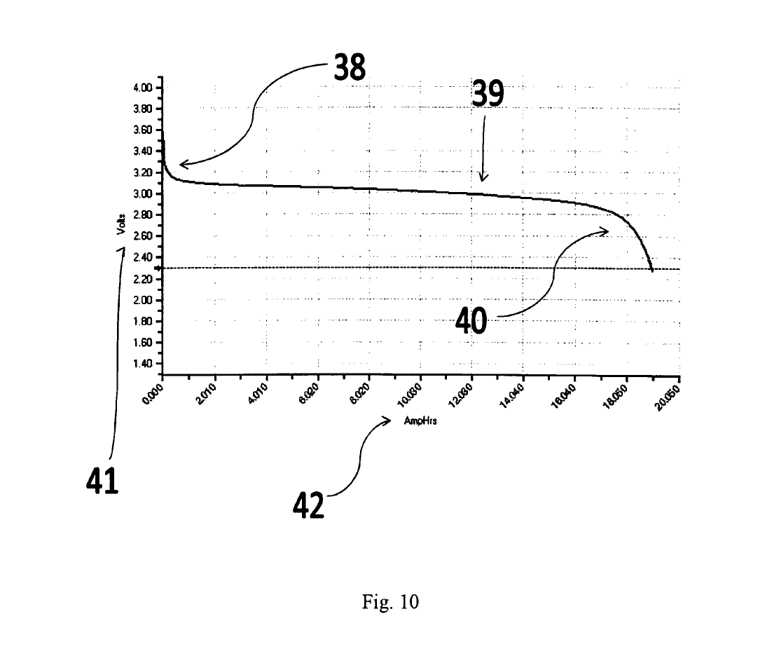

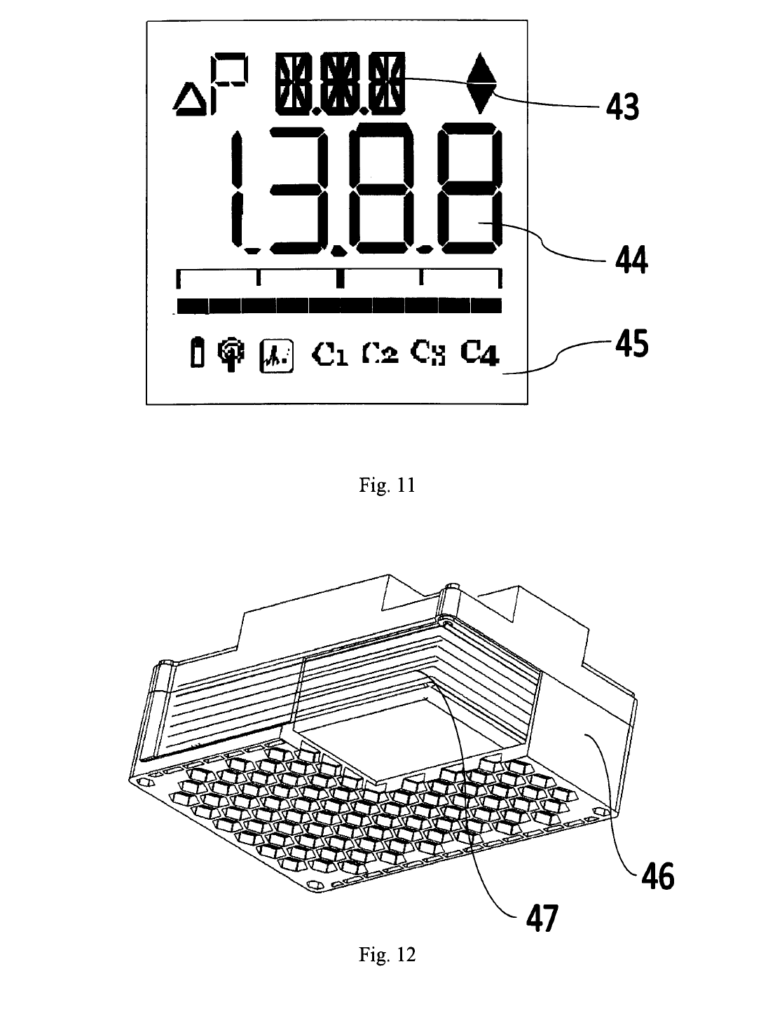

FIGS. 2 through 9 show the battery pack elements. The casing (1) and the cover (2) contain all the essential components of the battery pack. Visible on the outside are the casing handles (6), the terminals (3, 4), the terminal threads (5, 13, 17, 18, 20, 21), the push-button (34) and the LCD screen (12).

The casing shown in FIGS. 2, 4 and 5 corresponds in height and width to standard casings for lead batteries, which allows a broad application of the battery pack without a need for car modifications. The terminals (3, 4) can be connected from either side of the battery pack to required places, so that the battery could be used in automobiles with differently positioned battery clamps.

The butt (7) at the bottom of the casing serves to receive the battery pack in the car to hold faster in place.

Within the casing (1) are the battery cells (8). Depending on the cell type, capacity and area of application, there can be more or less of the cells. The more cells are series-connected, the higher voltage is obtained, the more of them are parallel-connected, the higher capacity is obtained. FIGS. 3, 6, 7, 8 and 9 show an example where the cylindrical cells in a configuration 4 series-, 3 parallel-connected are used. Physically they are held in place by the holders (35) inside the casing, the metal plates (22, 19, 31, 33), which also serve for electrical connection, and extra holders. When four battery cells (8) of this type are series-connected, the voltage obtained is similar to that of the conventional 12V lead batteries. For a 24V battery (e.g., in a truck), it would be necessary to series-connect eight instead of four cells (8). The shown examples use metal plates (9) for mutual connection in series or in parallel. FIG. 12 shows an example with flat cells (47) inside the casing (46). For the flat cells different methods of terminal connection are used.

The number of cells in parallel can be added as needed. If more current is required, more cells are added into parallel connection. In terms of monitoring and management, more cells in parallel are treated as one separate cell.

The battery cells (8) are mutually connected in parallel by metal plates (22, 19, 31, 33) and screws (32) or in series or parallel by other means. For example, the metal plate (22) connects at once three positive terminals (30) and three negative terminals (23) and thus simultaneously connects cells in series and parallel. The metal plates in the shown examples have relief holes (23, 24, 25). Through the metal plates (16, 19, 22) current flows from the battery cells (8) to the consumers and vice versa in case of charging. To each of the cells (8) a positive (29) and a negative (23) terminals are connected leading to the BMS. In that way the BMS monitors the voltage of each cell.

The LCD screen (12) spends very little electricity and thus does not generate a significant cost that can shorten the battery's life. It displays data such as cell temperature (43), total voltage or the voltage of individual cells (44), heating status (45) (ON/OFF), etc.

The battery management system designed to keep the working temperature of the starter battery pack containing more battery cells (8) of the new generation of lithium-ion; lithium-iron-phosphate cells mutually connected in series and parallel. The said system incorporates the unit (14) for cell temperature management and measurement, and voltage measurement of each individual battery cell (8) and for cell heating management (8). The unit (14) generates in real time the temperature signals of the cells. The unit (14) incorporates a temperature sensor mounted directly on one of the cells (8), the screen (12) that displays cell temperature data (43), total voltage or individual cell voltage (44), and the heating status (45) of the cells (8). The said system contains data on the predefined upper temperature value t₂ and the lower temperature value t₁ and the push-button (34) for manual activation or deactivation of cell heating; where the working temperature of the battery cells (8) is kept up by a heater (28, 33) in the form of foil pasted over the cells, or in case of flat cells (8) by a heater in the form of flat foil placed in between the cells (8) or by a shared heater of any form inside the casing (1). All cavities between the adjacent battery cells (8) and the casing (1) and the battery cells (8) are filled with isolation foam, which prevents temperature loss from the battery pack. For heating the cells (8) the electric power of the cells (8) themselves is used. The upper temperature value t₂ amounts to 5° C., and the lower temperature value t₁ 0° C. However, in dependence on the characteristics of individual cells, other upper temperature t₂ and lower temperature t₁ values can be set.

The working temperature maintenance procedure for the above described system involves the following steps:
input of data on upper temperature t₂ and lower temperature t₁ values;
input of data on permissible voltage drop value;
input of time interval data to detect the non-use of the battery pack;
checking in step (108) whether the push-button (34) for cell heating activation or deactivation is pressed or not;
if the push-button (34) is active, the heating status (45) of the battery cells (8) is changed and in step (110) it is checked whether or not the heating function is on;
if the heating function is on, what follows is temperature t′ measurement of the battery cell (8) and generation of measured temperature t′ signals;
checking in step (111) if the measured temperature t′ is lower than the lower temperature value t₁, where, if the measured temperature t′ is lower than the set temperature t₁, in step (112) cell heating is activated; and
heating the cells (8) and generating the signals in real time on temperature t′ of the battery cells (8) until the cell temperature is equal to or higher than the higher temperature value t₂, after which in step (113) cell heating is discontinued.

As far as known so far about the characteristics of the Li-ion battery cells, for their reliable work the lower temperature value t₁ should not go below 0° C., although it is already at temperatures below 15° C. that they manifest poorer performance. However, in dependence on the characteristics of the cells (8), appropriate temperature values t₂ and t₁ are set. Furthermore, depending on outdoor conditions or depending on the use of the starter battery pack, the user manually deactivates the cell heating function with the push-button (34), thus preventing the discharging of the battery pack. After the cell heating is off, the voltage of all cells is checked.

In case of the non-use of the battery pack, aimed to save energy, the heating function is automatically switched off, where the non-use of the battery pack is detected by:
periodical voltage measurement of the cells (8) according to a predefined time interval;
calculating the voltage difference between two periodical measurements and by memorizing the voltage difference value,
where, if the voltage difference value is smaller than the permissible voltage drop value, the non-use of the battery pack is detected.

If no voltage change has occurred outside the predefined permissible voltage difference value (for example, 1 V difference) over a time longer than, say, 48 hours, it means that the battery has not been used for a longer period of time.

With the push-button (34) on the cover (2) the user can manually activate or deactivate heating. If the user does not want to have the heating option activated, that option can be switched off by pressing the push-button (34), which makes sense if the car has been standing idle for a long time without being driven at low temperatures—in that case it may happen that as a result of cell heating the battery gets empty after a certain time, because electric power from the cells themselves is being used for cell heating. The unit (14) in step (108) checks if the push-button (34) is pressed or not. If pressed, the heating function status (109) will change. The unit (14) checks if the heating function is active (110). If it is, the unit (14) checks if the temperature of the battery cells (8) is higher than the adjusted limit (111). The limit (111) consists of data on the upper temperature value t₂ and the lower temperature value t₁. If the measured temperature t′ of the cells (8) is lower than the temperature t₁ cell heating in step (112) will be activated. If the measured temperature t′ of the cells (8) is higher than the temperature t₂, cell heating in step (113) will be deactivated and the procedure returns to the beginning of the loop and the first step is restarted—checking the cell voltage (101).

1. The battery management system for maintaining the working temperature of the starter battery pack containing more battery cells (8) of the new generation of lithium-ion; lithium-iron-phosphate battery cells mutually connected in series and parallel, where the said system incorporates the unit (14) for cell temperature management and measurement, and voltage measurement of each individual battery cell (8) and for cell (8) heating management, which unit (14) in real time generates the temperature and voltage signals of the battery cells (8), characterized in that the unit (14) incorporates a temperature sensor mounted directly on one of the cells (8); the screen (12) displaying the cell temperature data (43), the total and/or individual cell voltage (44); furthermore, the said system contains data on the predefined upper temperature value t₂ and the lower temperature value t₁ and the push-button (34) for manual activation or deactivation of cell heating; where the working temperature of the battery cells (8) is kept up by a heater (28, 33) in the form of foil pasted over the cells, or, in case of flat cells (8) by a heater in the form of flat foil placed in between the cells (8) or by a shared heater of any form inside the casing (1).

2. The system (14) according to claim 1, characterized in that all cavities between the adjacent battery cells (8) and the casing (1) and the battery cells (8) are filled with isolation foam or other isolation material, which prevents temperature loss from the battery pack.

3. The system (14) according to claim 1, characterized in that the electric power of the cells themselves (8) is used for cell heating.

4. The system according to claim 1, characterized in that the upper temperature value t₂ and the lower temperature value t₁ are adjusted according to the characteristics of the cells.

5. The process for maintaining the working temperature of the system defined in the foregoing claims, characterized in that it involves the following steps:
input of data on the upper temperature value t₂ and the lower temperature value t₁;
input of data on permissible voltage drop value;
input of time interval data to detect the non-use of the battery pack;
checking in step (108) whether the push-button (34) for the activation or deactivation of cell heating is active or not;
if the push-button (34) is active, the heating status (45) of the battery cells (8) will change and in step (110) checking is done to determine if the heating function is on;
if the heating function is on, temperature t′ measurement of the battery cell (8) and signal generation on measured temperature t′;
checking in step (111) if the measured temperature t′ is lower than the lower temperature value t₁, where, if the measured temperature t′ is lower than the set temperature t₁, in step (112) cell heating is activated; and
heating the cells (8) and generating in real time the signals on temperature t′ of each of the battery cells (8) until the cell temperature is equal to or higher than the upper temperature value t₂, after which in step (113) cell heating is discontinued.

6. The procedure according to claim 5, characterized in that depending on external conditions or depending on the use of the starter battery pack, the user manually deactivates the cell heating function with the push-button (34), thus preventing the discharging of the battery pack in the event of non-use for a longer period of time.

7. The procedure according to claim 5, characterized in that after the cell heating is off, the voltage of all cells (8) is checked.

8. The procedure according to claim 6, characterized in that in the event of the non-use of the battery pack, aimed to save energy, the heating function is automatically switched off.

9. The procedure according to claim 8, characterized in that the non-use of the battery pack is detected by:
periodical voltage measurement of the cells (8) according to a predefined time interval;
calculating the voltage difference between two periodical measurements and by memorizing the voltage difference value,
where, if the voltage difference value is less than the permissible voltage drop value, the non-use of the battery pack is detected.
